(19) United States
(12) Patent Application Publication
(10) Pub. No.: US 2013/0076774 A1
(43) Pub. Date: Mar. 28, 2013

(54) ELECTRONIC DEVICE HAVING FUNCTION OF AUTOMATICALLY ARRANGING ICONS AND METHOD THEREFOR

(71) Applicants: YING-CHUAN YU, Tu-Cheng (TW); YING-XIONG HUANG, Tu-Cheng (TW)

(72) Inventors: YING-CHUAN YU, Tu-Cheng (TW); YING-XIONG HUANG, Tu-Cheng (TW)

(73) Assignee: HON HAI PRECISION INDUSTRY CO., LTD., Tu-Cheng (TW)

(21) Appl. No.: 13/427,825

(22) Filed: Mar. 22, 2012

(30) Foreign Application Priority Data
Sep. 22, 2011 (TW) 100134046

(51) Int. Cl. G09G 5/32; G09G 5/10

(52) U.S. Cl. 345/589; 345/672

(57) ABSTRACT

The present disclosure provides an electronic device having a function of automatically arranging icons. The device includes a screen for displaying a plurality of icons, each icon corresponding to an application and a usage parameter, and a processing unit to record usage parameters of all the icons and update usage parameter of an icon if the corresponding application of the icon is run, and rearrange all the icons and display the rearranged icons on the screen.

### BACKGROUND

1. Technical Field

The present disclosure relates to electronic devices and, more particularly, to an electronic device having function for automatically arranging icons displayed on a screen of the electronic device and a method for automatically arranging the icons.

2. Description of Related Art

Icons displayed on a screen of an electronic device can be rearranged. For example, when a rearrangement operation for arranging the icons displayed on a screen is commanded by a user, the icons may be rearranged according to frequency of usage, size, or type of application represented by each icon. Nevertheless, a new arrangement method to automatically arrange the icons is still desired.

### BRIEF DESCRIPTION OF THE DRAWINGS

The components in the drawings are not necessarily drawn to scale, the emphasis instead being placed upon clearly illustrating the principles of the present disclose. Moreover, in the drawings, like reference numerals designate corresponding parts throughout the several views.

FIG. 1 is a schematic view of an electronic device having function of automatically arranging icons displayed on a screen of the electronic device, in accordance with an exemplary embodiment.

FIG. 2 is a schematic view showing that icons are displayed on the screen of the electronic device of FIG. 1 in a first embodiment.

FIG. 3 is a schematic view showing the icons are displayed on the screen of the electronic device of FIG. 2 after the icons on the screen are rearranged.

FIG. 4 is a schematic view showing that icons are displayed on the screen of the electronic device of FIG. 1 in a second embodiment.

FIG. 5 is a schematic view showing the icons are displayed on the screen of the electronic device of FIG. 4 after the icons on the screen are rearranged.

FIG. 6 is an arranging method to automatically arrange icons displayed on the screen of the electronic device in accordance with an exemplary embodiment.

### DETAILED DESCRIPTION

The disclosure is illustrated by way of example and not by way of limitation. It should be noted that references to “an” or “one” embodiment in this disclosure are not necessarily to the same embodiment, and such references mean at least one.

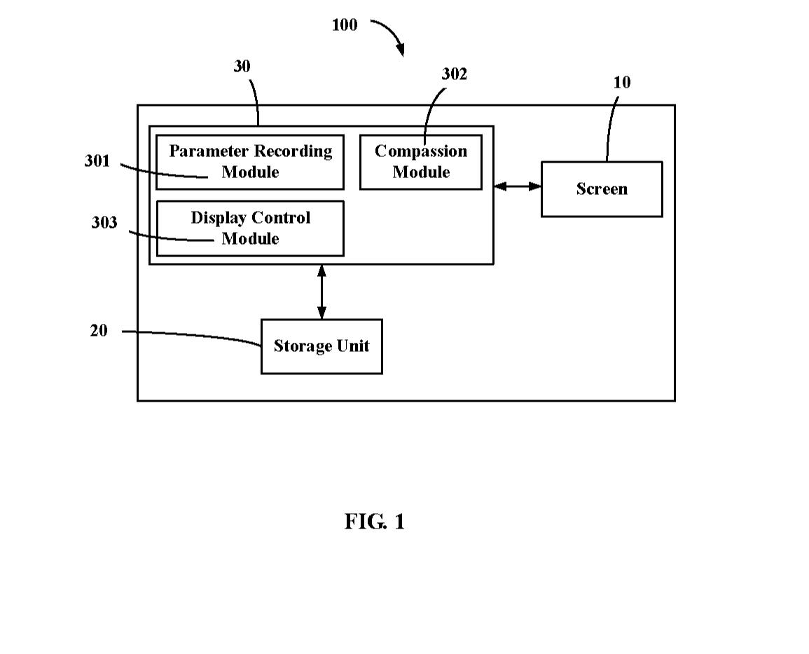

FIG. 1 is an electronic device 100 capable of automatically arranging icons displayed on a screen 10. The screen 10 displays a number of icons, each of which corresponds to an application and a usage parameter. The usage parameter may be running times which the application runs, latest running time that the corresponding application of the icon is run lastly, or running frequency of the application, for example. The electronic device 100 may be a computer, a Personal Digital Assistant, for example.

The electronic device 100 further includes a storage unit 20 and a processing unit 30. The storage unit 20 stores usage parameters of all the icons displayed on the screen 10. The processing unit 30 arranges all the icons to be displayed on the screen 10 according to an arrangement rule based on the usage parameters of all the icons, and further rearranges all the icons if the corresponding usage parameter of one of the icons is updated.

The processing unit 30 includes a parameter recording module 301, a compassion module 302, and a display control module 303. The parameter recording module 301 records usage parameters of all the icons and update the usage parameter of an icon if the corresponding application of the icon is run. The comparison module 302 compares the updated usage parameter of the icon whose corresponding application is run with usage parameters of the other icons to generate a compassion result. The display control module 303 rearranges all the icons according to the arrangement rule and the compassion result and display the rearranged icons on the screen 10.

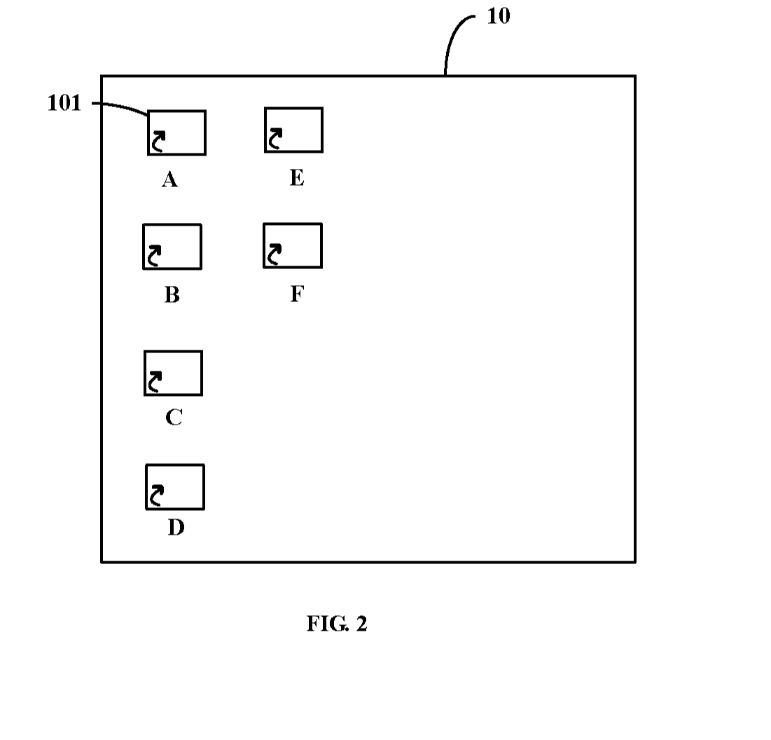

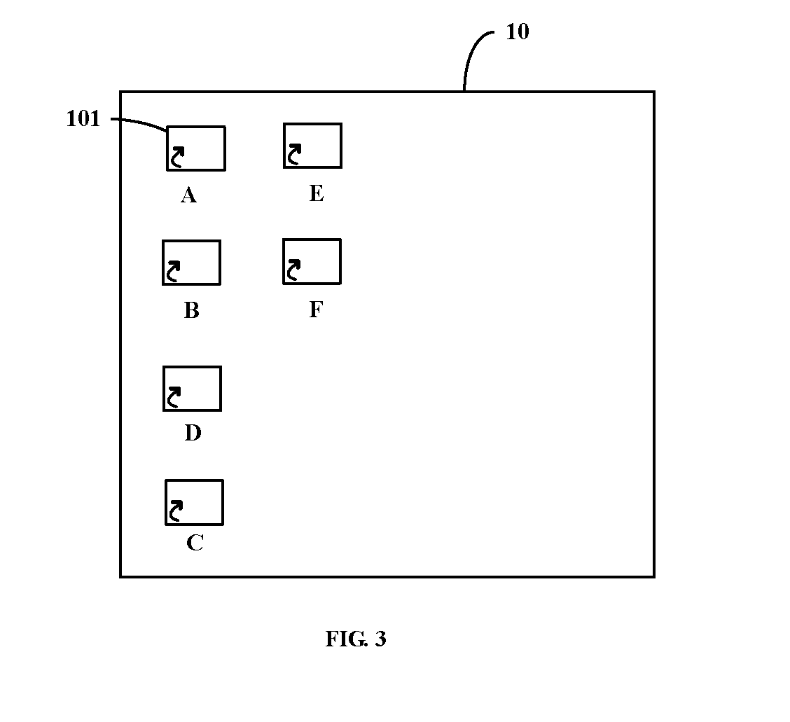

If the usage parameter of an icon 101 is the running times of the corresponding application of the icon 101, the arrangement rule is defined as that icons 101 are arranged orderly on the screen 10 according to the running times of each icon. Typically, icons having higher running times are arranged orderly on the upper and the left of the screen 10, and icons having lower running times are arranged orderly on the lower and the right of the screen 10. For example, as shown in FIG. 2, the corresponding running times of the icons A, B, C, D, E, and F respectively are 20, 15, 11, 11, 5, and 2. The display control module 303 arranges the icons A, B, C, D, E, and F to be displayed orderly according to descending order of the running times of all the icons. Thus, the icon with greater running times is displayed more prominently. After the icon D is operated to run the corresponding application of the icon D, the parameter recording module 301 updates the running times of the icon D to 12, and the comparison module 302 compares the running times 12 of the icon D with the running times of other icons, namely 20, 15, 11, 5, and 2, to generate the compassion result, namely the running times of the icon D (12 times) is greater than the running times of the icon C (11 times) and less than the running times of the icon B (15 times). The display control module 303 exchanges the position of the icon D and the icon C, as shown in FIG. 3.

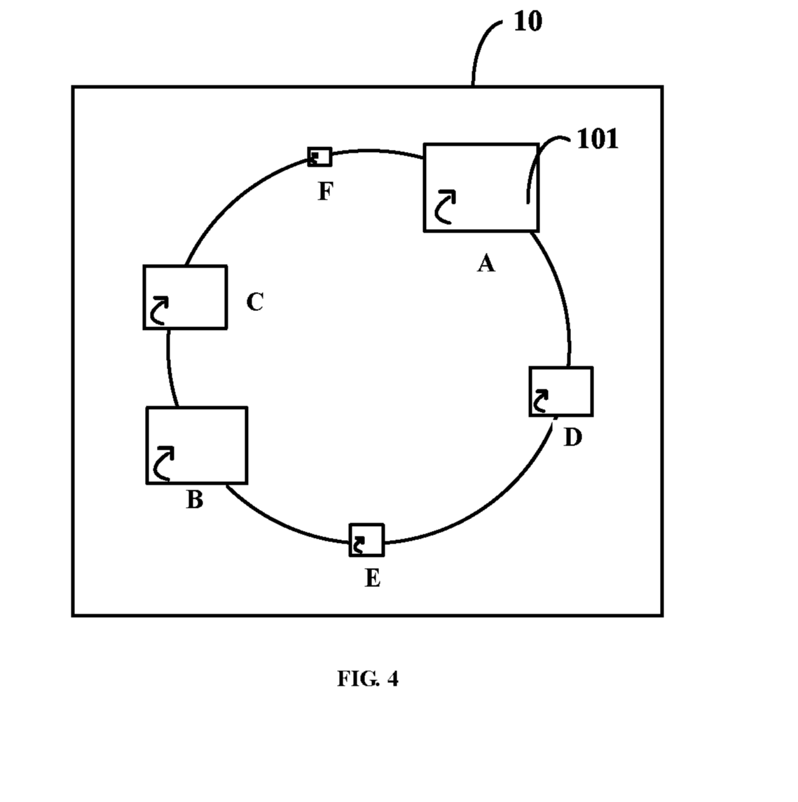

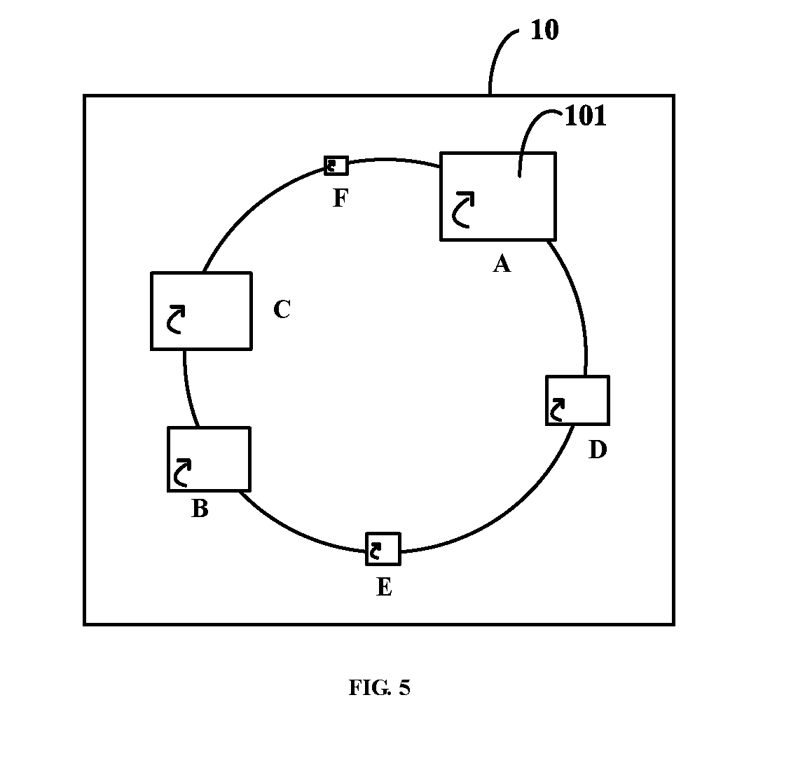

In another embodiment, the arrangement rule is defined as arranging icons in a loop form, and displaying the sizes of all the icons according to the running times of all the icons. Typically, icons having higher running times are displayed in a larger size, and icons having lower running times are displayed in a smaller size. FIG. 4 shows the icon A with a greatest running time has a largest size, thereby the icon A can be easier detected by an user, the icon F with a least running time has a smallest display area, and the running times of the icons B, C, D, and E are gradually decreased. For example, the icon A has a largest size 6 and the icon F has the smallest size 1, and the icons B, C, D, and E respectively have sizes 5, 4, 3, and 2. When the running times of the icon C is increased to be greater than that of the icon B and smaller than that of the icon A, the display control module 303 controls to exchange the sizes of the icon B and the icon C, as shown in FIG. 5, with the size of the icon B to be 4 and the size of the icon C to be 5.

In another embodiment, the arrangement rule is defined as displaying all the icons with different brightness according to the running time of each icon while maintaining the display location and the size of each icon to be unchanged.

In another embodiment, the usage parameter is the latest running time that the corresponding application of the icon 101 has run the last time. The display control module 303 controls the icons to be displayed according to the running time of the latest running of the corresponding application of each icon, to make an icon with the latest running time to be displayed more prominently.

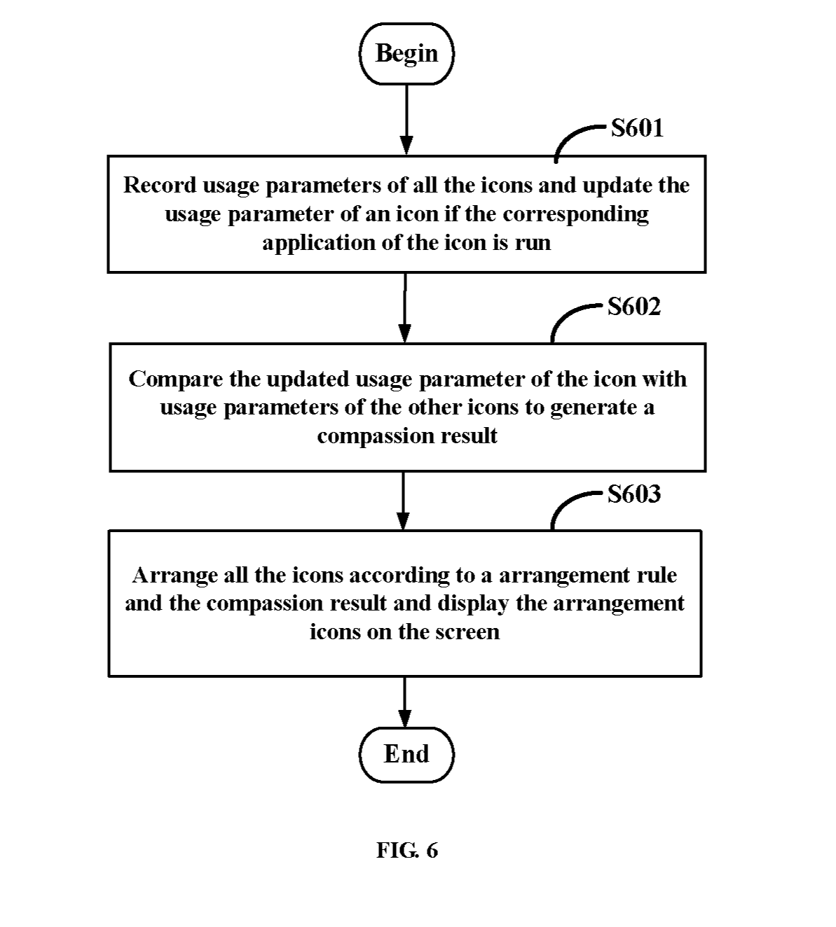

Referring to FIG. 6, an arranging method to automatically arrange icons displayed on a screen of the electronic device is disclosed. The arranging method includes procedures operated by the processing unit 30.

In step S601, the parameter recording module 301 is controlled by the processing unit 30 to record usage parameters of all the icons and update the usage parameter of an icon if the corresponding application of the icon 101 is run.

In step S602, the compassion module 302 is controlled by the processing unit 30 to compare the updated usage parameter of the icon whose corresponding application is run with usage parameters of the residual icons to generate a compassion result.

In step S603, the display control module 303 is controlled by the processing unit 30 to rearrange all the icons according to the arrangement rule and the compassion result and display the rearranged icons on the screen 10.

In one embodiment, the usage parameter of an icon is the running times of a corresponding application of the icon 101, and the displaying step is further implemented by the processing unit 30 to make an icon with greater running times to be displayed more prominently. In another embodiment, the usage parameter of an icon is a latest running time of a corresponding application of the icon 101 is run last time, and the processing unit 30 controls the display control module to make an icon with latest running time to be displayed more prominently in the displaying step.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device having function of automatically arranging icons, comprising:
a screen for displaying a plurality of icons, each icon corresponding to an application and a usage parameter;
a storage unit for storing usage parameters of all the icons displayed on the screen; and
a processing unit, comprising:
a parameter recording module to record usage parameters of all the icons and update usage parameter of an icon if the corresponding application of the icon is run;
a comparison module to compare the updated usage parameter of the icon whose corresponding application is run with usage parameters of the residual icons to generate a compassion result; and
a display control module to rearrange all the icons according to an arrangement rule and the compassion result and display the rearranged icons on the screen.

2. The electronic device as described in claim 1, wherein the usage parameter of an icon is the running times of a corresponding application of the icon, and the display control module is implemented by the processing unit to make an icon with greater running times to be displayed more prominently.

3. The electronic device as described in claim 2, wherein the arrangement rule is defined as that icons are arranged orderly on the screen according to the running times of each icon.

4. The electronic device as described in claim 2, wherein the arrangement rule is defined as that arranging each icon in a loop form with a fixed position, and displaying the sizes of all the icons according to the running times of each icon.

5. The electronic device as described in claim 2, wherein the arrangement rule is defined as displaying all the icons with different brightness according to the running time of each icon while maintaining display location and size of each icon to be unchanged.

6. The electronic device as described in claim 1, wherein the usage parameter of an icon is a latest running time that the corresponding application of the icon is run last time.

7. The electronic device as described in claim 6, wherein the display control module is implemented by the processing unit to make an icon with latest running time to be arranged and displayed more prominently.

8. An arranging method to automatically arrange icons displayed on a screen of an electronic device, the arranging method comprising steps operated by a processing unit to:
record usage parameters of all the icons and update usage parameters of an icon if the corresponding application of the icon is run;
compare the updated usage parameter of the icon whose corresponding application is run with usage parameters of the residual icons to generate a compassion result; and
rearrange all the icons according to an arrangement rule and the compassion result and display the rearranged icons on the screen.

9. The arranging method as described in claim 8, wherein the usage parameter of an icon is the running times of a corresponding application of the icon, and the displaying step is further implemented by the processing unit to make an icon with greater running times to be displayed more prominently.

10. The arranging method as described in claim 8, wherein the usage parameter of an icon is a latest running time of a corresponding application of the icon is run last time, and the displaying step is further implemented by the processing unit to make an icon with latest running time to be displayed more prominently.

11. A system for automatically arranging icons, the system comprising:
a parameter recording module to record usage parameters of all the icons and update usage parameter of an icon if the corresponding application of the icon is run;
a comparison module to compare the updated usage parameter of the icon whose corresponding application is run with usage parameters of the residual icons to generate a compassion result; and
a display control module to rearrange all the icons according to an arrangement rule and the compassion result and display the rearranged icons on a screen of an electronic device.
